(19) United States
(12) Patent Application Publication
(10) Pub. No.: US 2008/0281484 A1
(43) Pub. Date: Nov. 13, 2008

(54) Data Acquisition System

(76) Inventors: Brian Scott Seybert, Indianapolis, IN (US); James C. Stevens, Mooresville, IN (US); Todd Rezac, Westfield, IN (US); Timothy Corbett, Nineveh, IN (US)

Correspondence Address: BAHRET & ASSOCIATES, 320 NORTH MERIDIAN STREET, SUITE 510, INDIANAPOLIS, IN, 46204, US

(21) Appl. No.: 12/090,210

(22) PCT Filed: Oct. 16, 2006
(86) PCT No.: PCT/US2006/040220

§ 371 Date: Apr. 14, 2008

Related U.S. Application Data
(60) Provisional application No. 60/727,161, filed on Oct. 14, 2005.
(60) Provisional application No. 60/728,037, filed on Oct. 17, 2005.

(51) Int. Cl. G06F 19/00

(52) U.S. Cl. 701/33

(57) ABSTRACT

A data acquisition system for a vehicle, including a plurality of sensors for sensing the value of a condition relative to the vehicle; at least one collector electronically connected with and configured to receive first data from at least one of the sensors and configured to output second data to a host controller; a host controller electronically connected with and configured to receive second data from at least one collector and configured to store the second data for later access; and, fiber optic cable means connected between the host controller and the at least one collector for carrying the second data from the at least one collector to the host controller.

### CROSS-REFERENCE TO RELATED APPLICATIONS

This application claims the benefit of U.S. Provisional Patent Application Ser. Nos. 60/727,161 filed Oct. 14, 2005, and 60/728,037 filed Oct. 17, 2005, both of which are hereby incorporated by reference in their entirety.

### FIELD OF THE INVENTION

The present subject matter relates generally to data acquisition equipment. More specifically, the present invention relates to a data acquisition system utilizing optical fiber to transmit information between remote data collectors and a host controller.

### BACKGROUND

Data acquisition equipment or systems are used to capture data such as velocity, temperatures, and pressure, among others, for later analysis. What are needed are systems and techniques to improve data acquisition systems.

### SUMMARY OF THE INVENTION

The present subject matter provides data acquisition equipment. The data acquisition equipment includes remote data collectors connected to a host controller using optic fiber. The remote units are small and light weight with low power usage and include a plurality of voltage input channels. The host controllers include a plurality of optical channel inputs and storage media and may be small and light weight with low power usage. The host controllers may further be compatible with various communications methods, including, for example Ethernet, serial, CAN, etc. and may be capable of telemetry for remote monitoring. The host controllers may utilize a custom operating system and be capable of running on-board applications to process data.

An advantage of the data acquisition equipment is it may be capable of telemetry from remote locations.

Another advantage of the data acquisition equipment is the capability of using CAN communication to accept data from other sources.

A further advantage of the data acquisition equipment is the optical transmission of data from remote data collectors to host controller at main collection point.

Yet another advantage of the data acquisition equipment is reduces the number of wires and overall weight of data acquisition equipment.

Another advantage of the data acquisition equipment is low power usage.

A further advantage of the data acquisition equipment is the use of solid state components to eliminate moving parts.

Yet another advantage of the data acquisition equipment is a personal computer may be used to view and process the data acquired.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

The drawing figures depict one or more embodiments of the invention, by way of example only, not by way of limitations. In the figures, like reference numerals refer to the same or similar elements.

FIG. 1 is a plan, diagramatic view of a data acquisition system 10 configured for use on a motor vehicle 11 in accordance with one embodiment of the present invention.

FIG. 2 is a plan view of a remote data collector 26 of the data acquisition system 10 of FIG. 1.

FIG. 3 is a plan view of remote data collector 70 of the data acquisition system 10 of FIG. 1 in accordance with another embodiment of the present invention.

FIG. 4 is a diagram showing the components of collector 26 of the data acquisition system 10 of FIG. 1.

FIGS. 5-14 are schematics of the components of collector 26 of the data acquisition system 10 of FIG. 1.

FIG. 15 is a perspective view of host controller 25 of the data acquisition system 10 of FIG. 1.

FIG. 16 is a perspective view of a host controller 92 of the data acquisition system 10 of FIG. 1 in accordance with another embodiment of the present invention.

FIG. 17 is a perspective view of another a host controller 93 of the data acquisition system 10 of FIG. 1 in accordance with another embodiment of the present invention.

FIG. 18 is a diagram showing the components of host controller 25 of the data acquisition system 10 of FIG. 1.

FIGS. 19-27 are schematics of the components of host controller 25 of the data acquisition system 10 of FIG. 1.

### DETAILED DESCRIPTION

For the purposes of promoting an understanding of the principles of the invention, reference will now be made to the embodiments illustrated herein and specific language will be used to describe the same. It will nevertheless be understood that no limitation of the scope of the invention is thereby intended. Any alterations and further modifications in the described processes, systems or devices, and any further applications of the principles of the invention as described herein, are contemplated as would normally occur to one skilled in the art to which the invention relates.

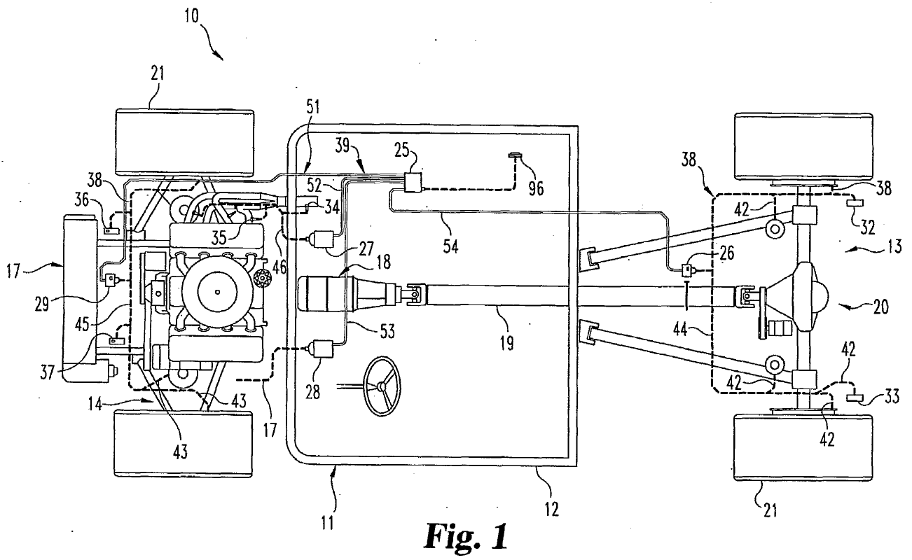

Referring to FIG. 1, there is shown a data acquisition system 10 configured for use on a motor vehicle 11 in accordance with one embodiment of the present invention. Motor vehicle 11 generally includes a body 12, a drivetrain 13 and a suspension system 14. The drivetrain includes the engine 17, transmission 18, driveshaft 19, differentials 20 and final drive elements, such as the wheels 21. Data acquisition system 10 generally includes. Motor vehicle 11 and its varied elements present hundreds of different values of interest, both in the moving and non-moving states. Each of these values is measurable using appropriate sensors, such as but not limited to, thermal (thermometers, thermocouples), electromagnetic (ohmmeters, ammeters), mechanical (pressure gauges, flow meters, acceleration sensors), chemical (oxygen sensors), RF ranging (RADAR), non-ionizing radiation (photodetectors), acoustic (microphones), and others (speedometer, tachometer, distance sensor).

Data acquisition system 10 (also referred to as data acquisition equipment) generally includes a host controller 25, four remote data collectors 26-29, a plurality of sensors such as at 32-37, a first data transmission system 38 for carrying electronic data from the sensors 32-37 to the collectors 26-29, and a second data transmission system 39 for carrying electronic data from the collectors 26-29 to host controller 25. While there are four collectors 26-29 shown, any number may be used as necessary and appropriate to group the data from the sensors and transmit it to host controller 25. Thus, there may be only one collector or 10 collectors or more.

The individual sensors may be any desired sensor appropriate for measuring the desired value. For example, sensors 32 and 33 at the rear of vehicle 11 are ride height sensors, while other rear sensors (not shown) connected to other, nearby branches 42 of the first data transmission system 38 could include, without limitation, shock travel sensors, wheel speed sensors, pressure sensors, axle center sensors and/or axis accelerometers, all of which are known to vehicle designers and manufacturers. At the front of vehicle 11, sensors 34 and 35 are oxygen sensors positioned in the exhaust system of engine 17, and sensors 36 and 37 are ride height sensors. Other sensors (not shown) connected to other, nearby branches 43 of the first data transmission system 38 could include, without limitation, shock travel sensors, wheel speed sensors, steering angle sensors, oil pressure sensors, oil temperature sensors, water temperature sensors, MAP sensors, ACT sensors, TPS sensors, pressure sensors, RPM sensors and/or axis accelerometers, all of which are known to vehicle designers and manufacturers.

In the configuration shown in FIG. 1, the first data transmission system 38 comprises metallic wiring to connect the sensors to the appropriate controller, the controller being configured to communicate with its particular sensors. Thus, first data transmission system 38 includes a rear branch wiring 44 that extends from rear collector 26 and to each of the rear sensors (32, 33 and others not shown). Rear branch wiring 44 includes one wire for each sensor, though the wires may be bundled to facilitate a single 21 pin connector, for example, to controller 26. Likewise, first data transmission system 38 includes front branch wiring 45 that extends from front collector 29 and to each of the front sensors (36, 37 and others not shown), and includes mid branch wiring 46 and 47 that extends from mid collectors 27 and 28, respectively, and to each of oxygen sensors (34 and 35 and others not shown). It is preferred that the collectors be located proximal its group of sensors to minimize the length and weight of wires in the overall branch wiring. Each collector 26-29 is then connected by a single cable (51, 52, 53 and 54) of second data transmission system 39 to host controller 25, as shown, to transmit data thereto.

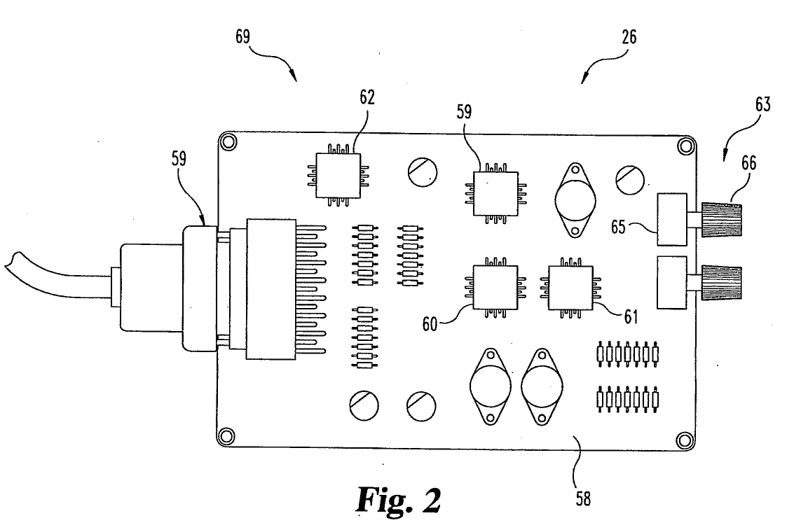

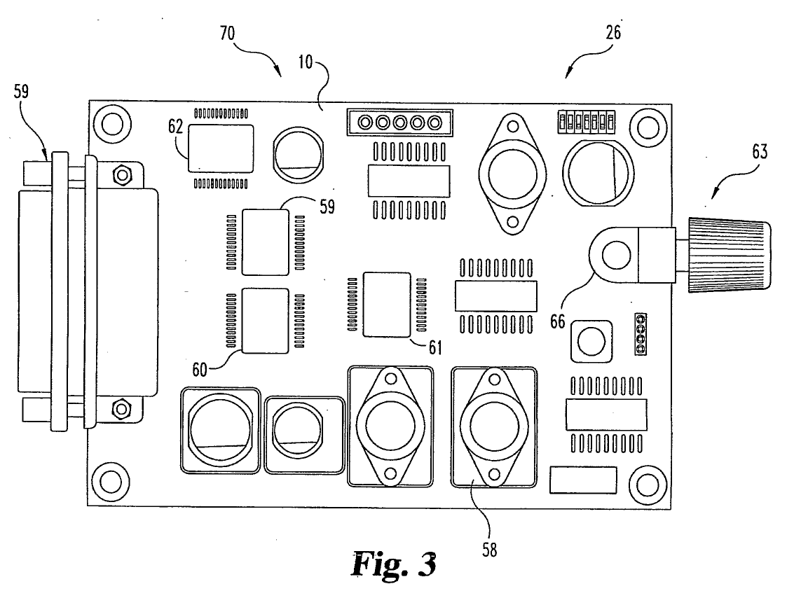

Referring to FIGS. 2 and 3, two embodiments of a remote data collector, such as collector 26, for example, are shown. Collector 26 will be discussed more specifically herein, it being understood that other collectors (27-29 and others not shown) will be the same or similar, as necessary to communicate between their connected sensors and the host controller 25. A plurality of collectors 26-29 and others may be connected to host controller 25 such that information collected by each of the collectors is transmitted to and stored by host controller 25.

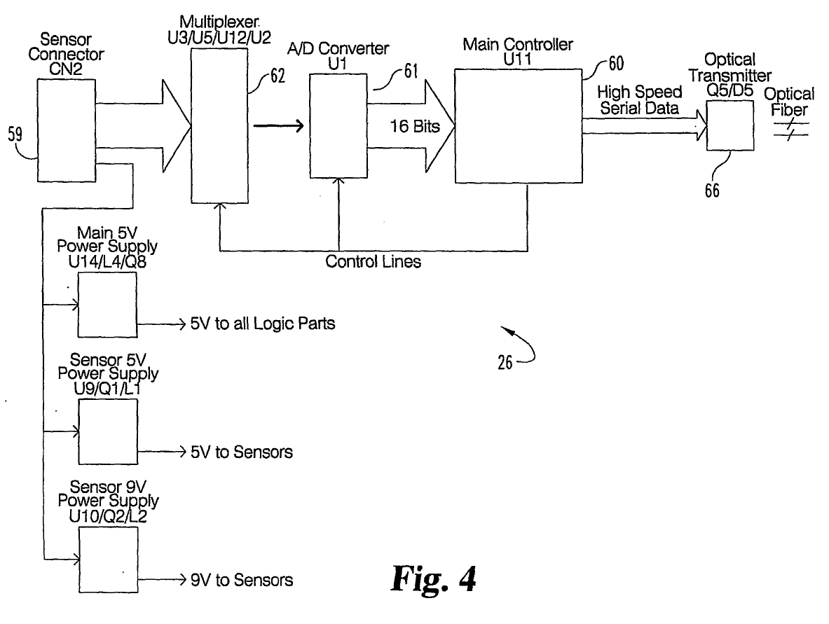

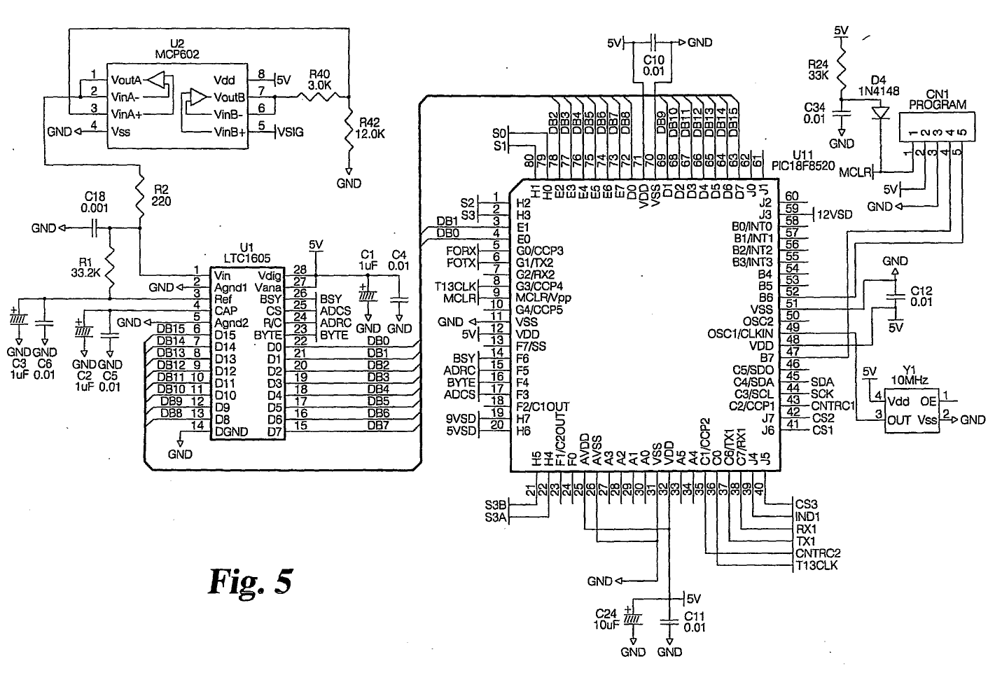

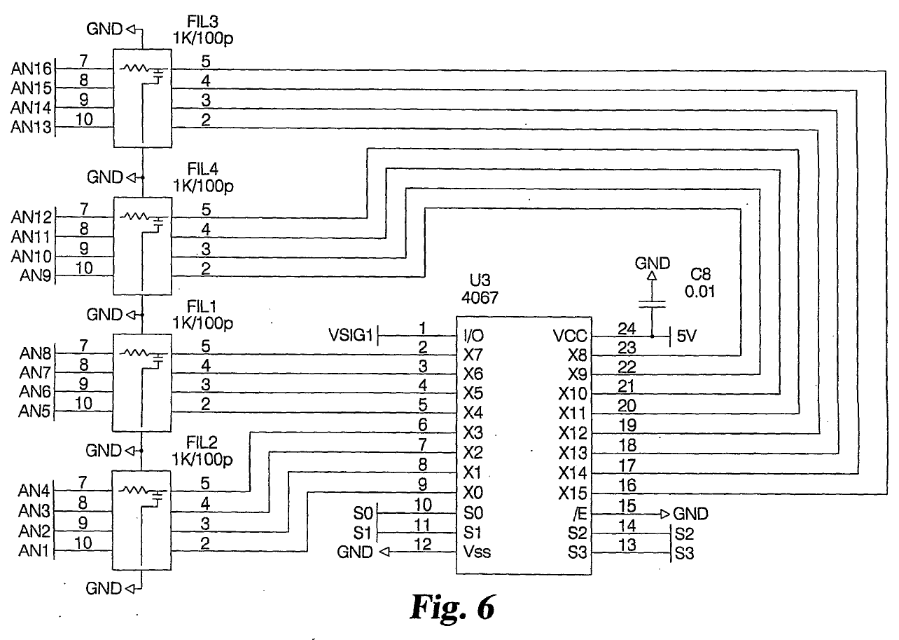

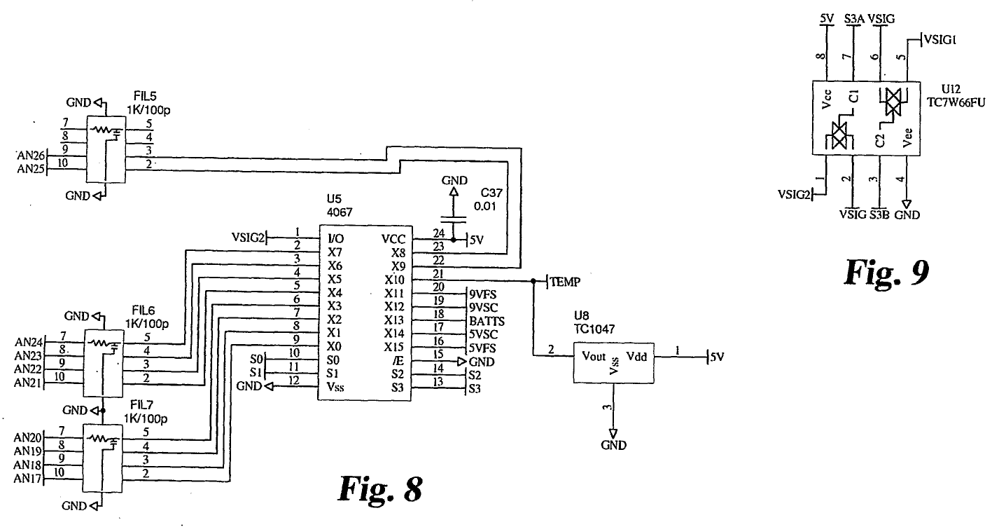

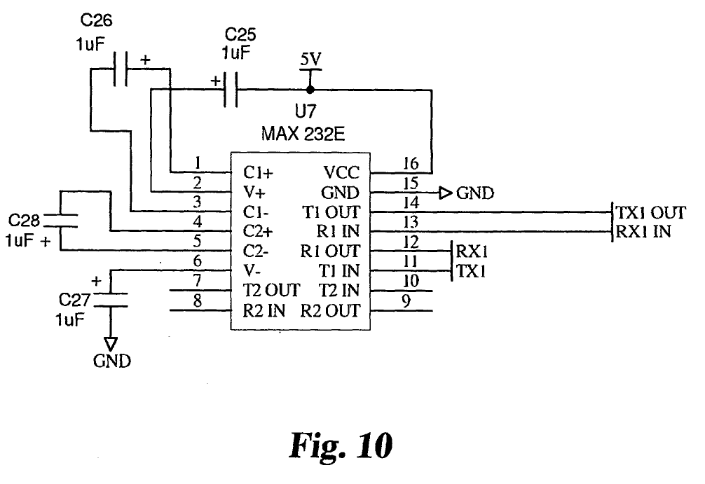

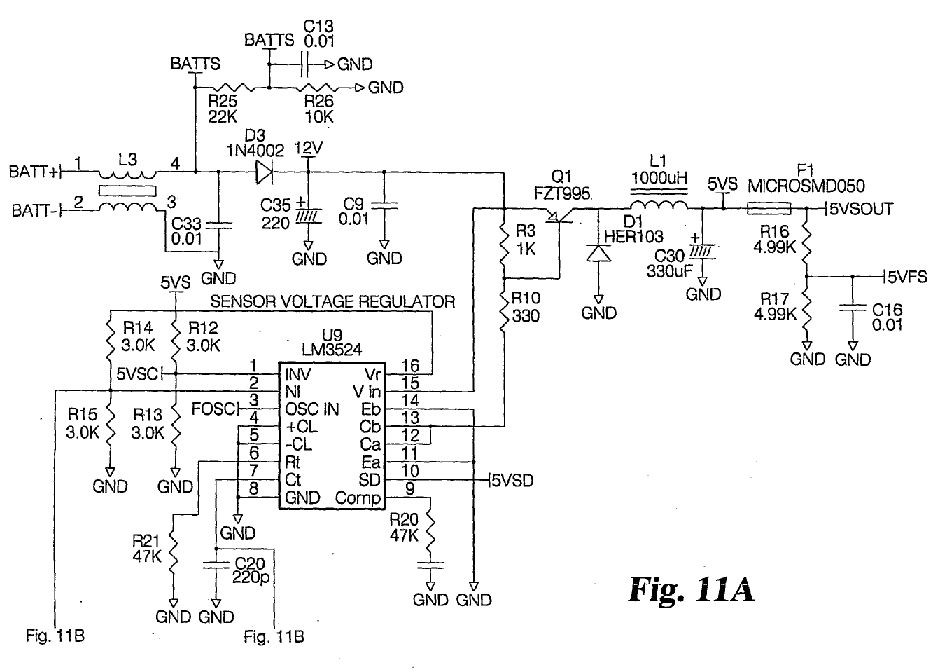

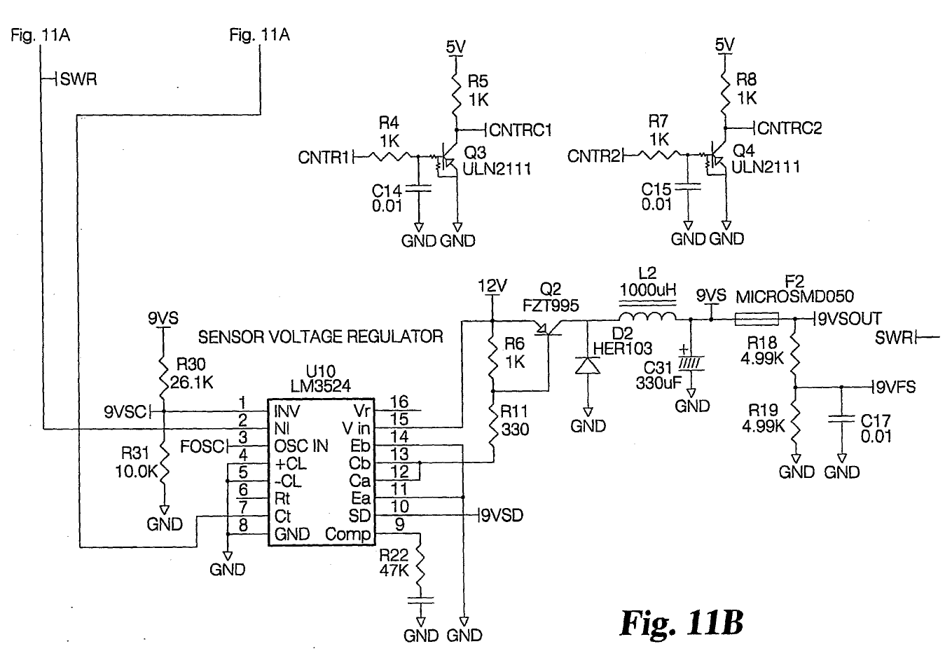

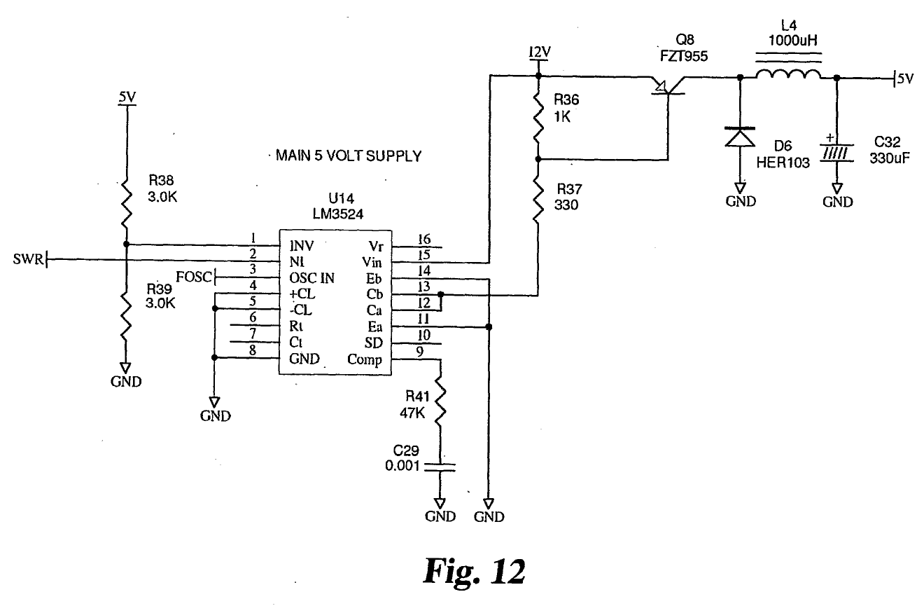

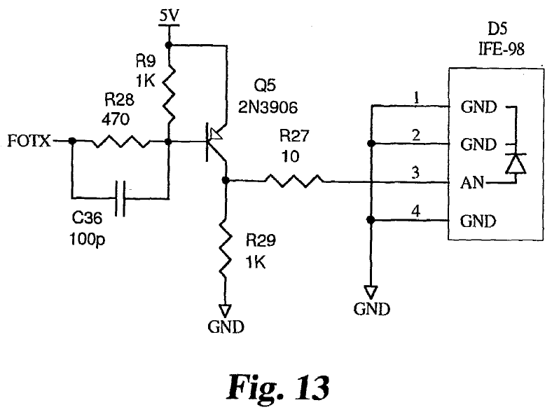

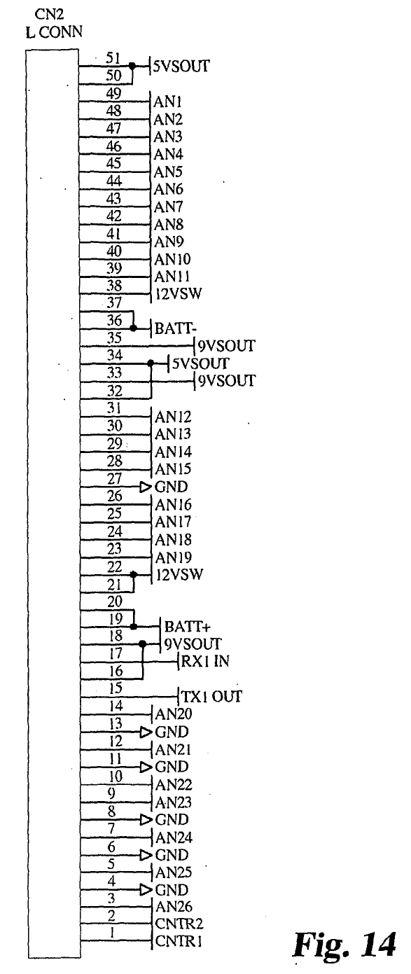

Collector 26 of FIG. 2 generally includes a circuit board 58, an analog input 59, a microprocessor (main controller) 60, an analog to digital converter 61, a multiplexer 62, and at least one optical output assembly 63 to send a digital signal to host controller 25. Circuit board 58 also includes a host of other various electrical elements (e.g. capacitors, resistors, etc.), power supply connections, and connections among the components 59-63, as needed, only some of which are shown. Analog input 14 is configured for 26 voltage input channels, which permits up to 26 sensors to connect with collector 26. Collector 26 may, however, be configured for any number of analog inputs so long as board 58 is properly designed to accept and process such number. Optical output assembly 63 includes an optical transmitter 65 and an optical connector 66. The analog input data received through analog input 59, is passed through multiplexer 62, A/D converter 61, and optical transmitter 66, and outputted as a digital signal to second data transmission system 39. Multiplexer 62 sequentially captures an analog data value from an individual sensor and provides the value to the analog to digital converter 61 to be converted to a digital value. Remote data collector 26 provides the digital value to host controller 25 via its optical outputs and the fiber optic cables of second data transmission system 39. The components of collector 26 are shown in diagram form in FIG. 4, the schematic for which is shown in FIGS. 5-14. Alternative embodiments are contemplated wherein other configurations as would be obvious to persons skilled in the art are used. In one example, and without limitation, the collector 26 of FIG. 3 (collector 69) shows a single optical output assembly 63, while the collector 26 of FIG. 2 (collector 70) shows a single optical output assembly 63 and an optical input assembly 68 to enable digital data to be received by collector 70 whereby manipulation of data can be made directly on board 58 from external input. Sensors connected to collector 70 and/or the data from such sensors, can then be adjusted in real time to provide more accurate data and to provide desired end-result data more quickly.

Software is provided to microprocessor 60 to control the collection, manipulation and output of the sensor data, as described herein and as desired for the most efficient operation of data acquisition system 10. Any appropriate software may be used.

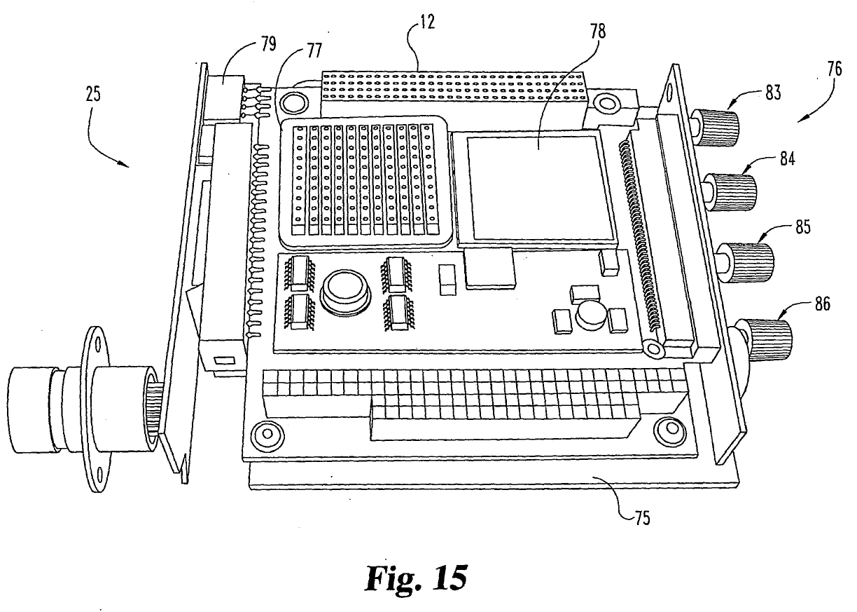

Referring to FIG. 15, host controller 25 generally includes a circuit board 75, a plurality of optical receiver assemblies 76, a microprocessor (main controller) 77, data storage medium 78, a GPS assembly 79, a dataport 80 and various other electrical elements (e.g. capacitors, resistors, etc.), power supply connections, and connections among the components 76-79, as needed, only some of which are shown. Optical receiver assemblies 76 here include four such assemblies, each assembly including an optical receiver 88 and an optical connector 89. As with the microprocessor 60 of controller 26, microprocessor 77 is provided with any appropriate software necessary to control the data collection, manipulation, storage and output of board 75.

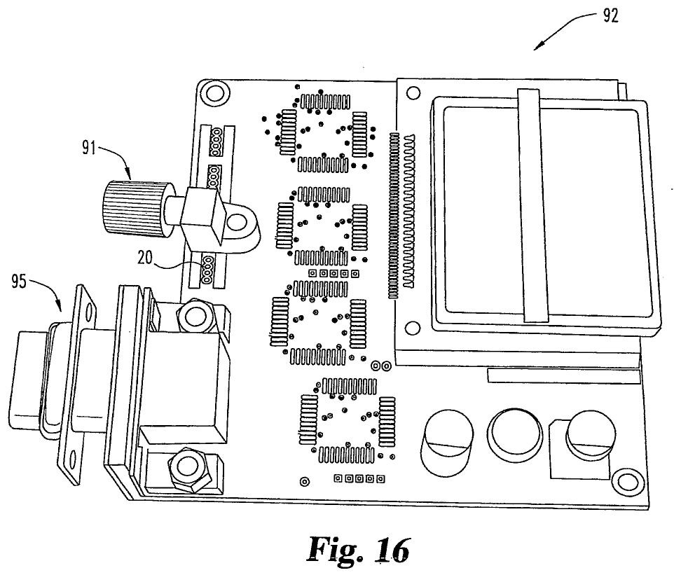

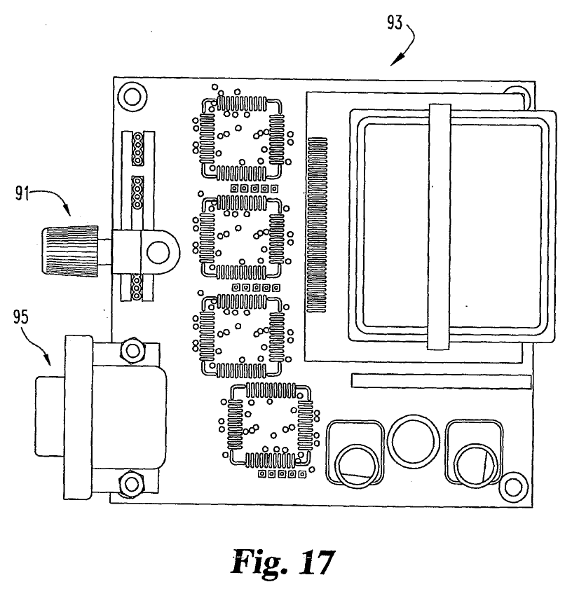

Storage medium 78 is a compact flash memory card having sufficient memory to retain all data that is anticipated to be collected by the various sensors of data acquisition system 10 over a selected amount of time. The host controllers 92 and 93 of FIGS. 16 and 17 are provided with a less powerful microprocessor, less memory and only one optical assembly 91. Such less powerful controls 92 and 93 are nevertheless powerful enough to receive digital data at its optical assembly 91 from the second data transmission system 39, store such data in the memory cards 94 and control the interface with an external computer through its data port 95 and the output of the data from its memory through data port 95. Host controller 25 of FIG. 15 is intended to possess sufficient power on board to process the data it receives and produce the desired end result.

The GPS assembly 79 is configured as known in the art to connect with appropriate GPS satellite to provide host controller 25 with global positionment of the vehicle through its GPS sensor 96.

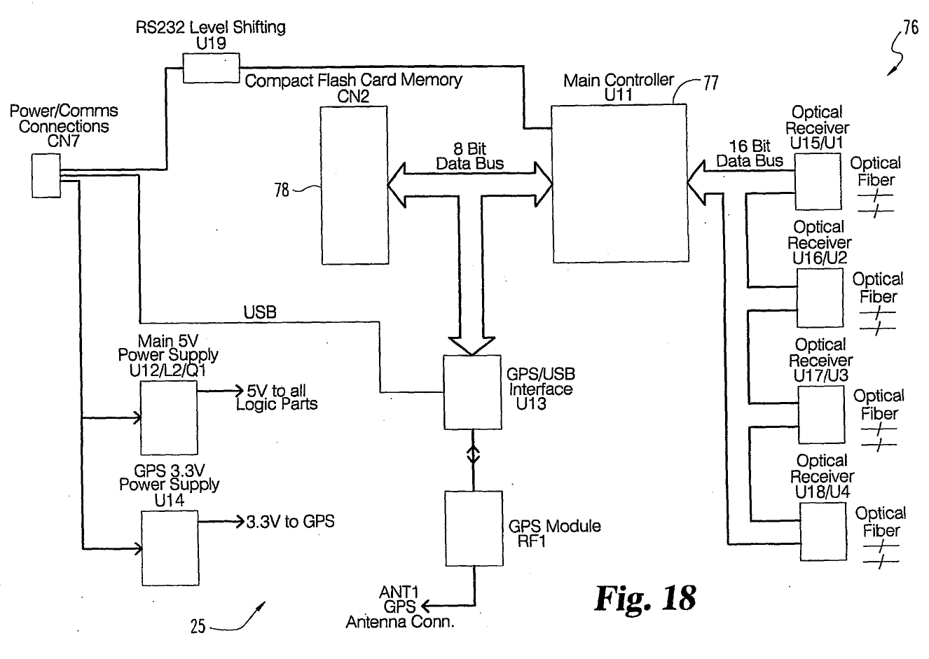

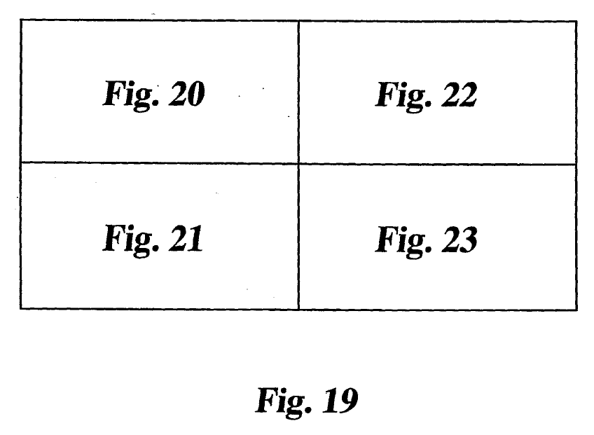

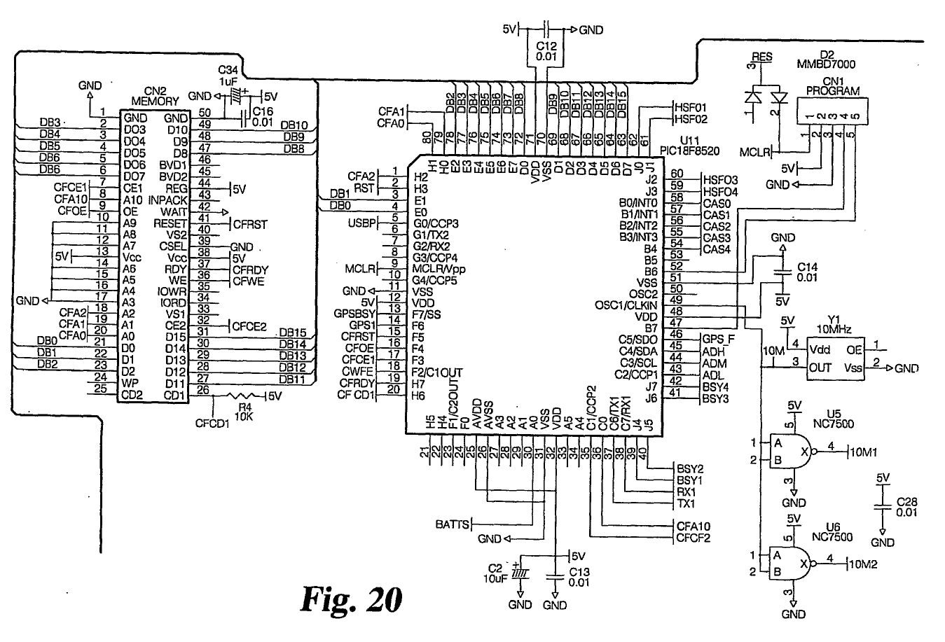

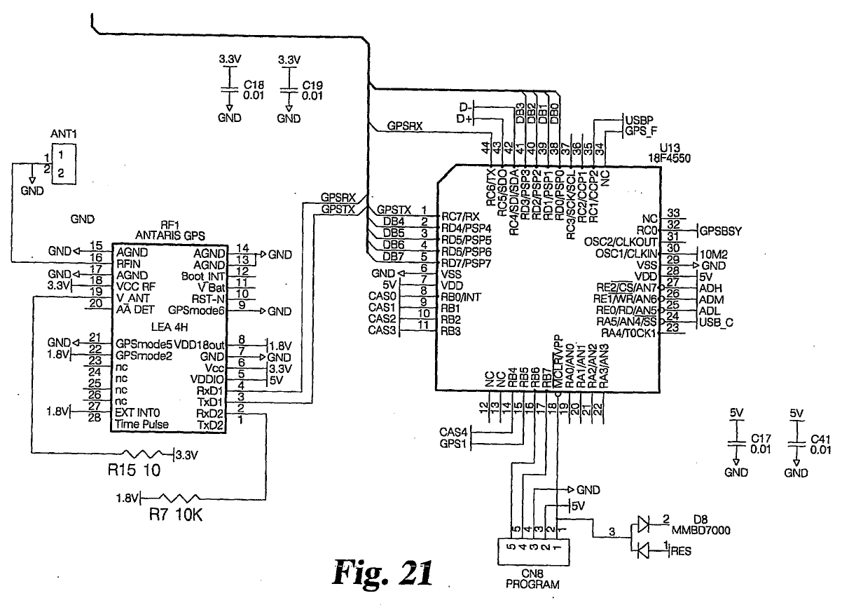

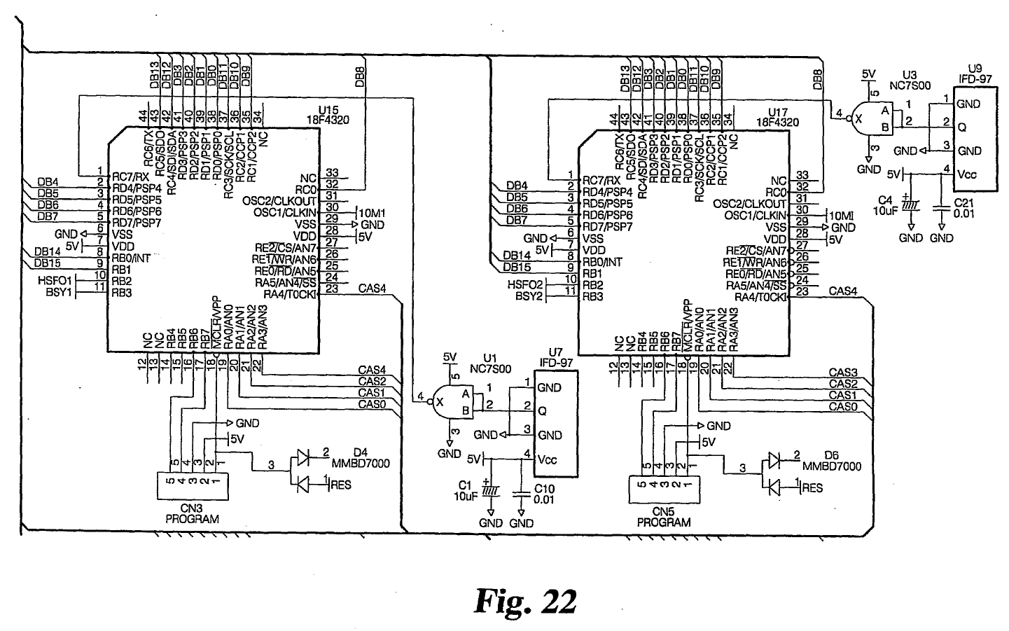

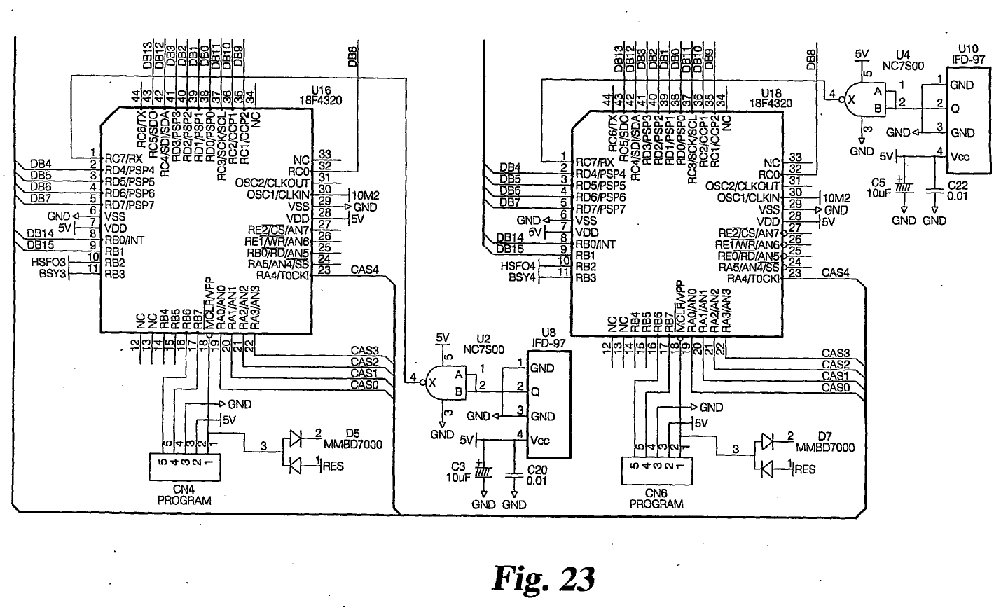

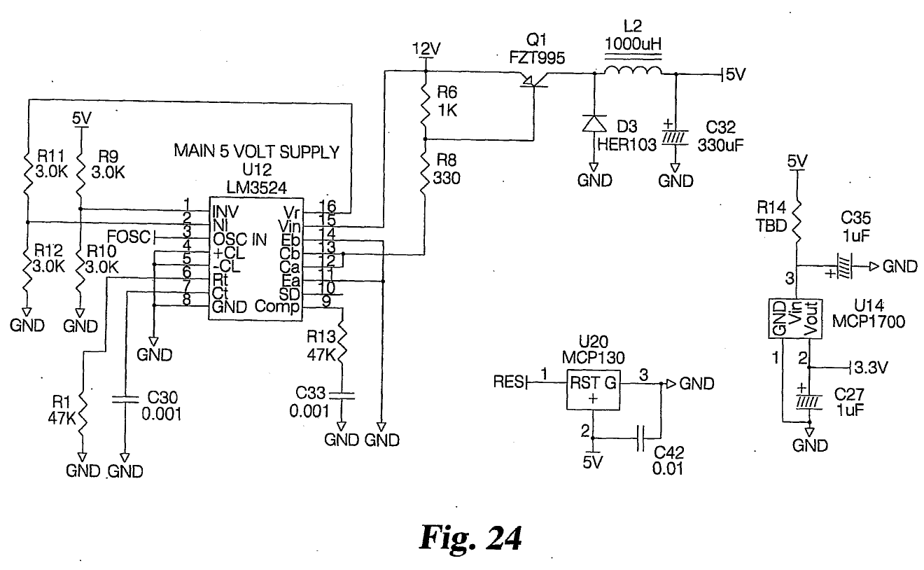

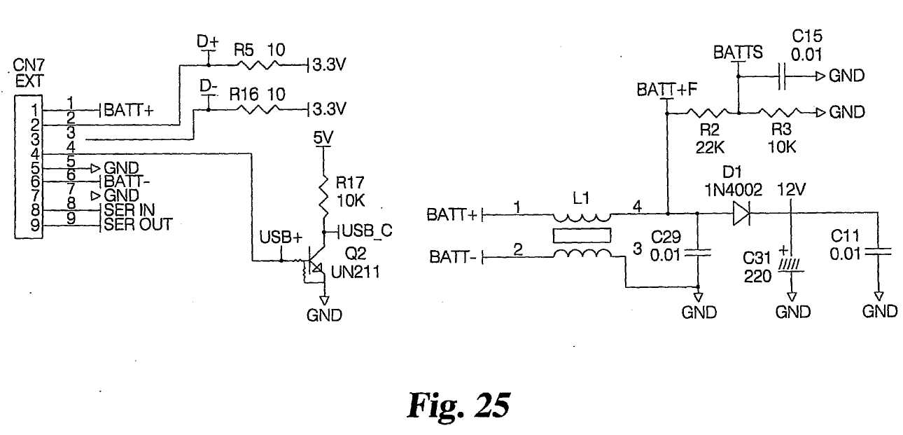

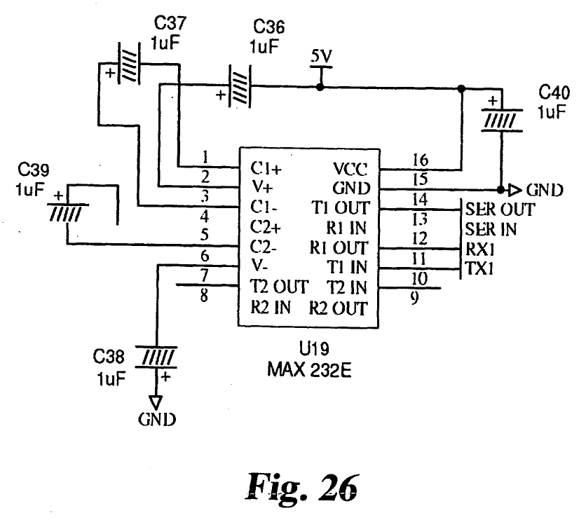

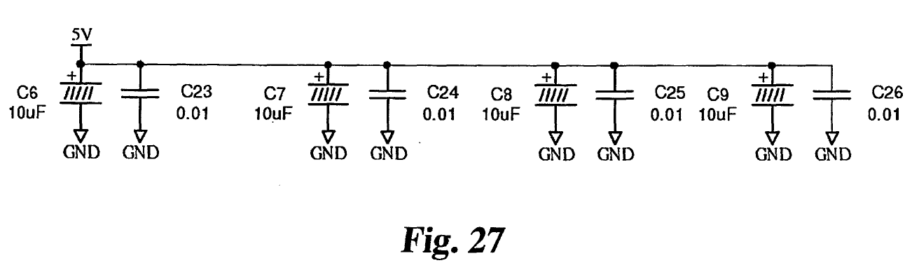

The components of host controller 25 are shown in diagram form in FIG. 18, the schematic for which is shown in FIGS. 19-27. Alternative embodiments are contemplated wherein other configurations as would be obvious to persons skilled in the art are used.

The second data transmission system 39 generally includes fiber optic cables 51, 52, 53 and 54 connected to the optical connectors 66 at the collectors 26 and extending to the optical connectors 83-86 on the host controller 25. The optical transmitters 65 and the optical receivers mounted on the circuit boards of the collectors 26 and host controller 25 process the electrical data into light for transmission through the second data transmission system 39. The second data transmission system 39 is considerably lighter than the hundreds of metallic wires it replaced.

Host controller 25 may include optical inputs 20 for receiving data from the remote data collectors 26, but may also receive one or more metallic inputs, if desired. The optical inputs 20 may be, for example, four optical channel inputs (104 analog channels) or any may be any number necessary to handle the data from the various collectors 26. As further shown in FIGS. 15-17, host controllers 25 can be various sizes and configurations such that the host controllers 25 may include storage media, such as, for example, flash memory and outputs for various communication methods, such as, for example, Ethernet, serial, CAN, etc. For example, the storage media may provide 7.5 gigabytes of storage. Host controllers 25 may further be various sizes and weights depending upon the features and functions provided by the host controllers 25. Host controllers 25 may also be capable of telemetry for remote monitoring. Host controllers 25 may utilize custom operating system, such as, for example, a custom Linux operating system, and be capable of running on-board applications to process data.

While host controller 25 does function as a collector of data, for clarity it is referred to herein as a host controller in that it functions as a central collector, controller and storage and communications unit.

All of the components of the data acquisition equipment provided herein may be solid state in order to avoid moving parts. The data acquisition equipment or system 10 provided herein may further be connected to another processor, such as, for example, a personal computer to additionally view and process the collected data.

Alternative embodiments contemplate multiple sensors connected to a single remote data collector. Remote data collector 34 includes optical outputs, analog to digital converter 35, and multiplexer 37. Data generated from multiple sensors 36 is provided to the input plane of remote data collector 34.

The data acquisition equipment provided herein may be used to collect any type of voltage-transmitted data. In one example, the data acquisition equipment provided herein may be used in the automobile industry. For example, the remote data collectors 10 may receive information, via analog input 14, generated from one or more potentiometers. The potentiometers may be used in an automobile, for example, to generate information relating to the automobile's wheel position, automobile engine temperature readings, readings from counters or any other type of information that may be measured or transmitted using voltage or a change in voltage generated by a potentiometer. Similarly, the data acquisition equipment could be used in association with other vehicles, such as, for example, boats or aircraft. The data acquisition equipment can similarly be employed in any number of related and unrelated applications to collect various types of information. For example, the data acquisition equipment could be used in conjunction with manufacturing equipment to collect information regarding the number of units produced by the equipment or the status and conditions of the manufacturing equipment.

In one embodiment, front remote data collector 26 can be configured to capture 32 signals: 30 voltage signals and 2 counter signals. Sensors near the front side of the car include: ride height distance sensor, such as a laser range finder or those using ultrasonic or radar techniques; wheel speed sensor such as a Hall effect or reluctor sensor; linear potentiometer to measure the travel of a shock; rotary potentiometer to measure the steering wheel angle; oil pressure sensor; oil temperature sensor; water temperature sensor; Manifold Absolute Pressure (MAP) sensor; Air Charge Temperature (ACT) sensor; multi-axis accelerometers; a Throttle Position Sensor (TPS) such as a rotary potentiometer; and sensor to measure engine revolutions per minute (RPM).

Rear remote data collector 26 includes a multiplexer and an analog to digital converter. The multiplexer is used to selectively feed the analog to digital converter with alternating sensed values from the variety of sensors connected to it. Rear remote data collector 26 is configured and located to receive signals from sensors located near the rear of the car. In one embodiment, rear remote data collector 26 can be configured to capture 32 signals: 30 voltage signals and 2 counter signals. Sensors near the rear of the car include: ride height distance sensor such as a laser range finder or those using ultrasonic or radar techniques; linear potentiometer to measure the travel of a shock; wheel speed sensor such as a Hall effect or reluctor sensor; pressure sensor to measure the pressure of the lubricant in the differential; potentiometer to measure the location of the center of the axle; and multi-axis accelerometers.

First O2 data collector 27 utilizes a generic O2 sensor configured to sense and output the oxygen content in the exhaust gas. First O2 data collector 27 is used to capture four primary O2 measurements for each of the four headers proximal the exhaust ports from a first side of the engine, as well as one tailpipe O2 measurement. In a same fashion, second O2 data collector 28 is used to capture four primary O2 measurements for each of the four headers proximal the exhaust ports from a second side of the engine, as well as one tailpipe O2 measurement.

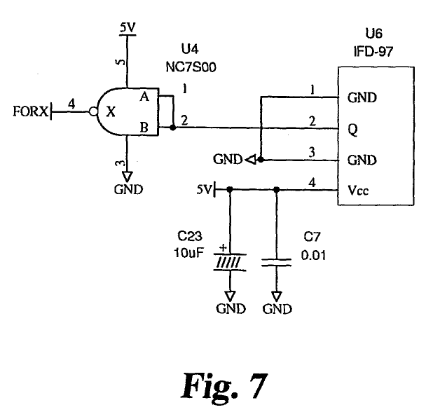

Host controller 25 is used to capture data from various data collectors, depicted in FIG. 1 as front remote data collector 29, rear remote data collector 26, first O2 data collector 27, and second O2 data collector 28. Host Controller 25 is also depicted in FIG. 7 as capturing data from GPS receiver 96 that can be arbitrarily positioned on the motor vehicle. Data collected by host controller 25 can be stored in memory until needed for later use. In some embodiments, data can be downloaded to a personal computer that is connected directly to host controller 25. In other embodiments, data can be transmitted via wireless transmission thru a radio connected thereto. In some embodiments, host controller 25 can include up to four inputs, but could include greater or fewer than four in other embodiments. Host controller 25 can also be operatively connected to other devices through a serial link, CAN link, USB, or any other suitable communication mechanism.

As further described, the data acquisition equipment provided herein may be used in association with equipment and may include one or more remote data collectors including an analog input for receiving information relating to status or condition of the equipment, an analog to digital converter and one or more optical outputs, wherein the remote data collectors are connected to a collector using optical fiber, the collector including a plurality of optical input channels and storage media.

Also as described, the data acquisition equipment provided herein may be used in association with a vehicle and may include one or more remote data collectors and a collector, the remote collector includes an analog input for receiving information relating to status or condition of the vehicle, an analog to digital converter and one or more optical outputs, wherein the remote data collectors are connected to a collector using optical fiber which is coupled between an optical output on the remote data collector and an optical input on the collector, the collector includes storage media, wherein the collector communicates the collected or stored information to a remote processor and further includes an on-board processor for running on-board applications to process data.

It should be noted that various changes and modifications to the presently preferred embodiments described herein will be apparent to those skilled in the art. Such changes and modifications may be made without departing from the spirit and scope of the present invention and without diminishing its attendant advantages.

What is claimed is:

1. A data acquisition system for a vehicle, comprising:
a plurality of sensors for sensing the value of a condition relative to the vehicle at least one collector electronically connected with and configured to receive first data from at least one of said sensors and configured to output second data to a host controller;
a host controller electronically connected with and configured to receive second data from at least one collector and configured to store the second data for later access; and,
fiber optic cable means connected between said host controller and said at least one collector for carrying the second data from said at least one collector to said host controller.
